(19) United States
(12) Patent Application Publication
(10) Pub. No.: US 2005/0057219 A1
(43) Pub. Date: Mar. 17, 2005

(54) Apparatus and method for cell voltage monitoring

(75) Inventors: Chris Kaminski, Richmond (CA); David Leboe, Vancouver (CA); Michael Lee, Victoria (CA)

Correspondence Address: Oyen Wiggs Green & Mutala;The Station, Suite 480, 601 West Cordova Street, Vancouver, V6B 1G1, CA

(73) Assignee: Cellex Power Products, Inc.

(21) Appl. No.: 10/667,270

(22) Filed: Sep. 17, 2003

(51) Int. Cl. H02J 7/32

(52) U.S. Cl. 320/116

(57) ABSTRACT

A cell voltage monitoring device is powered internally by the stack being measured and uses no external power sources whatsoever. The cell voltage monitoring device comprises a plurality of differential amplifiers each corresponding to a cell within the stack. The differential amplifiers are divided into groups of a suitable number, each group corresponding to a set of series-connected cells being collectively measured by the differential amplifiers in that group. Within each group of differential amplifiers, the positive supply terminal of each differential amplifier is connected to the most positive output terminal of the corresponding set of series-connected cells, and the negative supply terminal of each differential amplifier is connected to the most negative output terminal of the corresponding set of series-connected cells. By doing so, each group of differential amplifiers is powered by the set of series-connected cells being measured by that group. A method of cell voltage monitoring based on this device.

### TECHNICAL FIELD

The present invention relates to electrical cell voltage monitoring devices and methods and, more particularly, electronic circuits for monitoring the output voltages of series-connected cells.

### BACKGROUND

Many applications, such as electrically powered vehicles, combine several cells in a series configuration called a stack to obtain higher voltages than can be obtained from each individual cell. Cells are energy sources providing direct current (DC) electrical energy, and may be battery cells, fuel cells or any kind of cells capable of providing DC electrical energy and capable of being connected in series. Cells have negative output terminals and positive output terminals, each of which has an electrical potential. The output voltage of a cell is the difference between the electrical potential at its positive output terminal and the electrical potential at its negative output terminal. Expected output voltages are variable within ranges determined by characteristic design features of the cells in question.

A plurality of series-connected cells is called a stack. The stack voltage of a stack is the sum of the output voltages of the cells forming the stack and is equal to the potential difference between the most positive and most negative output terminals.

It is known in the art that, especially for fuel cell applications but also for battery and other applications, it is desirable to monitor the output voltages of each individual cell, or group of cells, in a stack of series-connected cells. For example, with many cells connected in series, it is useful to measure the voltage of each cell (or group of cells) to verify that the stack is operating within normal and safe limits, to ensure its reliability and stability. Various electronic circuits for monitoring the output voltages of series-connected cells are known.

FIG. 1 shows a circuit schematic of a cell voltage monitoring device 10A disclosed in U.S. Pat. No. 6,147,499 to Torii et al. Referring to FIG. 1, a stack 18 comprises a plurality of series-connected cells 12. Other than the outermost two cells 12 in the stack 18, each cell 12 in the stack 18 has a positive output terminal 16 connected to a negative output terminal 14 of an adjacent cell 12 and a negative output terminal connected to a positive output terminal 16 of a different adjacent cell 12. At the outer ends of the stack 18, the one unconnected positive output terminal 16 serves as the positive stack output terminal 17 of the overall stack 18, and the one unconnected negative output terminal 14 serves as the negative stack output terminal 13 of the overall stack 18.

Measuring the output voltage of each cell 12 is a corresponding differential amplifier A which has one input connected to the positive output terminal 16 of the cell 12 and the other input connected to the negative output terminal 14 of the cell 12. Each differential amplifier A provides an output 20 corresponding to the voltage difference between the positive output terminal 16 and negative output terminal 14 of each corresponding cell 12. Each differential amplifier A is powered by an external power source DC₁, DC₂ . . . DCₙ applied between a positive power supply terminal 24 and a negative power supply terminal 22 of each differential amplifier A.

The differential amplifiers A are divided into a plurality of n groups G₁, G₂ . . . Gₙ (n≧2), each group G₁, G₂ . . . Gₙ having a suitable number of differential amplifiers A. As taught by Torii et al., in order to minimize undesirable background currents and to eliminate the need for gain trimming amplifiers, each group G₁, G₂ . . . Gₙ has its own corresponding mutually insulated external power source DC₁, DC₂ . . . DCₙ and its own corresponding mutually insulated ground GND₁, GND₂ . . . GNDₙ. All differential amplifiers A within a given group G₁, G₂ . . . Gₙ will have their positive power supply terminals 24 connected to the respective common external power source DC₁, DC₂ . . . DCₙ provided for that group and will have their negative power supply terminals 22 connected to the respective common ground GND₁, GND₂ . . . GNDₙ for that group. Each group G₁, G₂ . . . Gₙ is mutually insulated from all other groups.

However, having a separate mutually insulated external power source DC₁, DC₂ . . . DCₙ for each group G₁, G₂ . . . Gₙ of differential amplifiers A adds cost and complexity to the circuit, especially if there are many groups of differential amplifiers A (that is, if n is a large number). According to Torii et al., one insulating DC/DC converter is required for each group G₁, G₂ . . . Gₙ.

The fact that prior art cell voltage monitoring devices even need to have external power sources increases the cost and complexity of such devices.

### SUMMARY OF INVENTION

According to the present invention, a cell voltage monitoring device is powered internally by the stack being measured and uses no external power sources whatsoever to power the amplification circuitry (an isolated supply will still be required to power the output side of the isolator circuits in several of the embodiments). Rather, differential amplifiers in the cell voltage monitoring device are powered by the stack itself. In particular, the invention uses various voltage points within the stack of series-connected cells to power differential amplifiers between those points.

A cell voltage monitoring device according to the invention comprises a plurality of differential amplifiers each corresponding to a cell, or group of cells, within the stack. The plurality of differential amplifiers is divided into groups, each group corresponding to a set of series-connected cells within the stack. Within each group of differential amplifiers, the positive supply terminal of each differential amplifier is connected to the most positive output terminal of the corresponding set of series-connected cells, and the negative supply terminal of each differential amplifier is connected to the most negative output terminal of the corresponding set of series-connected cells. By doing so, each group of differential amplifiers is powered by the set of series-connected cells corresponding to the group.

The number of differential amplifiers in each group is selected so that the minimum expected supply voltage to each differential amplifier is greater than its minimum required supply voltage, and the maximum expected supply voltage to each differential amplifier is less than its maximum allowed supply voltage. The expected supply voltage of the differential amplifiers belonging to one group is equal to the sum of the expected output voltages of the series-connected cells corresponding to that group. Therefore, the greater the number of differential amplifiers within a group, the greater the number of corresponding cells, and the greater the supply voltage to differential amplifiers in that group. The minimum and maximum required supply voltage of a differential amplifier is a characteristic design feature of that differential amplifier.

The gain of each differential amplifier circuit is selected so that the maximum expected output voltage of the differential amplifier is less than its maximum output capability. The maximum output capability of a differential amplifier is the maximum output voltage that the differential amplifier can provide, which is dependent on the supply voltage provided to the differential amplifier.

The differential amplifiers according to the invention produce outputs referenced to different reference grounds for each group. The outputs of the differential amplifiers should be converted to a common reference ground so that the outputs can be processed by a common CPU. It is possible to convert such outputs through analog isolators. If so, then the outputs should first undergo some form of analog conditioning in order to reduce the number of outputs to convert, given the expense of analog isolators. Alternatively, to avoid the expense of analog isolators, it is also possible to first digitize the differential amplifier outputs using a separate ADC for each group of differential amplifier outputs, and then pass the digitized group outputs through digital isolators to the CPU. Digital isolators are much less expensive than analog isolators. In any event, it is preferable to minimize the number of groups into which differential amplifiers are divided in order to correspondingly minimize the number of isolators required to convert the measured outputs to a common reference ground, balancing this factor with above-mentioned factors which may encourage increasing the number of groups. Where an ADC digitizes the outputs from an entire group of differential amplifiers, the ADC can be voltage referenced to the potential of an output terminal of the corresponding set of series-connected cells, usually to the most negative output terminal of those cells.

The cell voltage monitoring device should also preferably be used in conjunction with separate means of measuring the overall stack voltage and the group voltages (the sum of the output voltages of the series-connected cells within each group), and preferably also the stack current (the stack current being the current drawn from the stack by a load). When the stack or group voltage is not within an acceptable range, whether compared to predetermined stack or group voltage thresholds or in relation to the stack current based on known polarization curves, it is likely that the cell voltage monitoring device outputs cannot be trusted, and the CPU should preferably be programmed to reject such outputs or otherwise take corrective action. Also, some hardware could be implemented to signal the CPU that the group voltage of the cells within a group is too low and the measurements cannot be trusted. This hardware could be as simple as a voltage comparator circuit.

### BRIEF DESCRIPTION OF DRAWINGS

FIG. 1 is a circuit diagram of a prior art device for measuring the output voltages of series-connected cells within a stack, with a separate and mutually insulated external power source and ground for each group of differential amplifiers measuring the cell voltages.

FIG. 2 is a circuit diagram of a cell voltage monitoring device according to the present invention showing differential amplifiers powered internally by voltage points within the stack of series-connected cells being measured by the differential amplifiers.

FIG. 3 is a circuit diagram of a circuit for converting to a common reference ground the outputs of the groups of differential amplifiers of FIG. 2, and for digitizing such outputs for processing by a digital controller (CPU).

FIG. 4 is a circuit diagram of an alternative circuit to that in FIG. 3, for first digitizing the differential amplifier outputs by group, and then converting the digitized group outputs to a common reference ground for processing by the digital controller (CPU).

FIG. 5 is a circuit diagram of a further alternative circuit to that in FIG. 3, for first reducing the number of differential amplifier outputs by group, and then converting the reduced set of group outputs to a common reference ground for processing by a controller (CPU).

FIG. 6 is a graph with two curves showing the expected and minimum allowable stack voltage for a given stack current.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

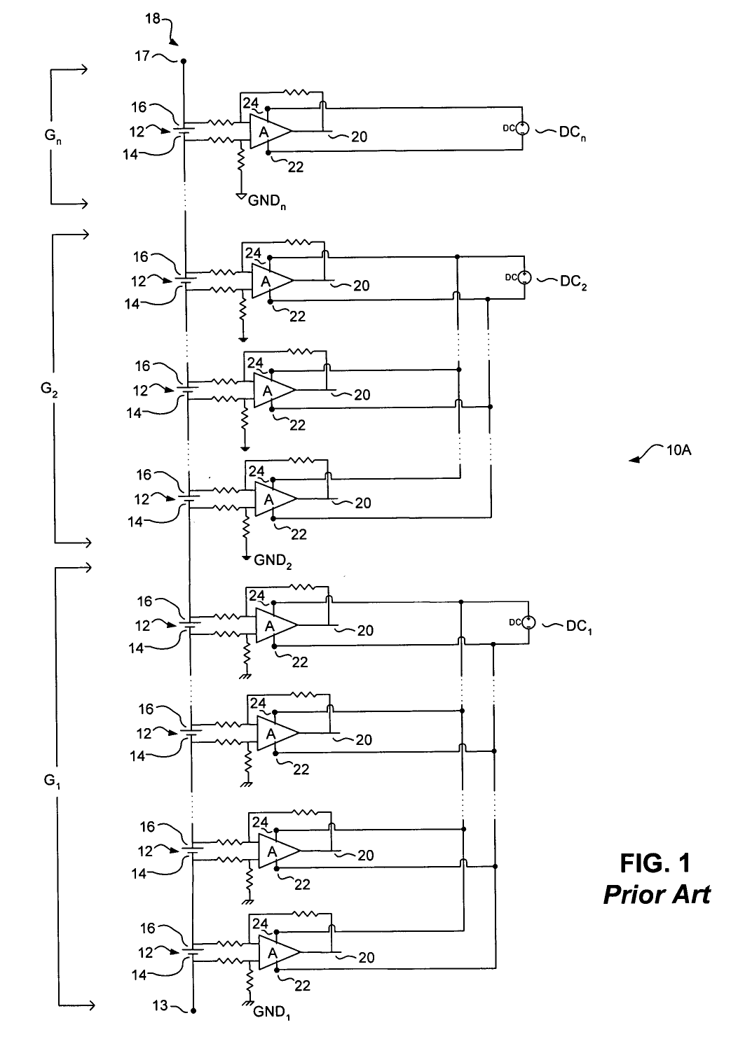

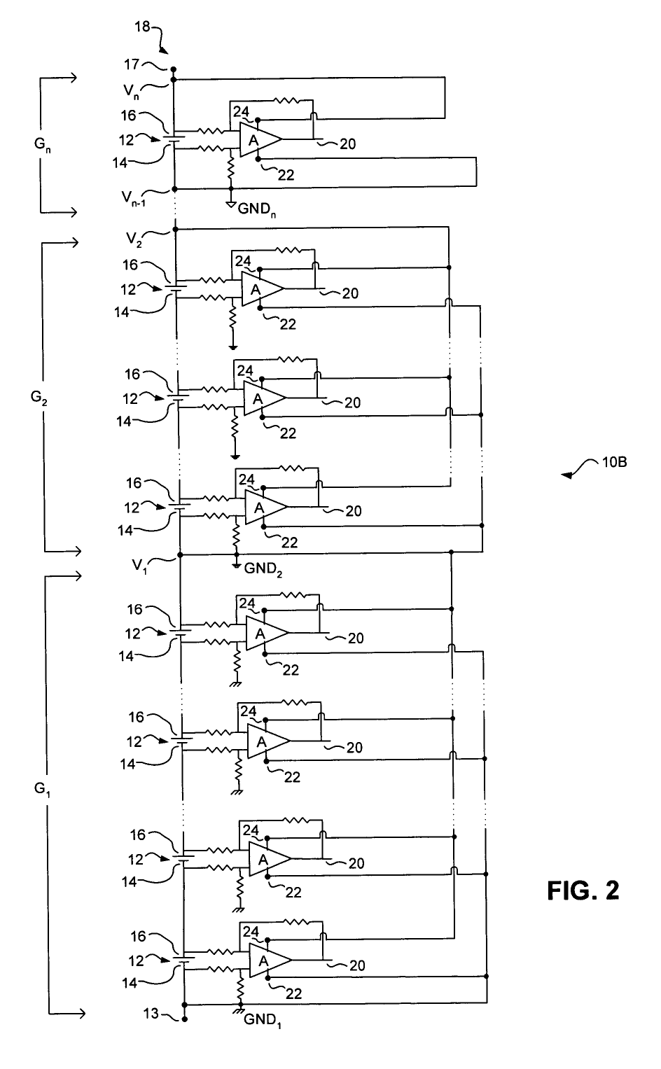

FIG. 2 is a circuit diagram of a cell voltage monitoring device 10B according to the present invention. Similar to the cell voltage monitoring device 10A in FIG. 1, the cell voltage monitoring device 10B in FIG. 2 measures the output voltages of a plurality of series-connected cells 12 in a stack 18 using a corresponding plurality of differential amplifiers A to each provide an output 20 corresponding to the difference in potential between the positive output terminal 16 and negative output terminal 14 of the corresponding cell 12. Also similar to the cell voltage monitoring device 10A, the cell voltage monitoring device 10B according to the invention divides the plurality of differential amplifiers A into a plurality of groups G₁, G₂ . . . Gₙ, n≧2, each having a suitable number of differential amplifiers A. Each differential amplifier A has a corresponding cell 12, and each group G₁, G₂ . . . Gₙ of differential amplifiers A has a corresponding group of series-connected cells 12. The groups G₁, G₂ . . . Gₙ need not have the same number of differential amplifiers A, or corresponding cells 12, as one another.

Referring to FIG. 2, cell voltage monitoring device 10B monitors respective output voltages of stack 18 of series-connected cells 12 by periodically or continually measuring output voltages of those cells 12. The output voltage of each cell 12 is the difference between the electrical potential at its positive output terminal 16 and the electrical potential at its negative output terminal 14. Cells 12 are connected in series to form a stack 18 having negative stack output terminal 13 and positive stack output terminal 17. Negative stack output terminal 13 is the most negative output terminal 14 of the series-connected cells 12 forming stack 18. Positive stack output terminal 17 is the most positive output terminal 16 of the series-connected cells 12 forming stack 18. The stack voltage of stack 18 is the difference in electrical potential between the positive stack output terminal 17 and the negative stack output terminal 13 and is equal to the sum of the cell voltages of the cells 12 forming stack 18. The stack current is the current drawn from stack 18 by a load connected to positive stack terminal 17 and negative stack terminal 13.

The measurements of the output voltages of the cells 12 are performed by differential amplifiers A. Preferably, the input terminals of each differential amplifier A are connected across only one cell 12 and measures the output voltage of its connected cell 12. However, if any differential amplifier A is connected across more than one cell 12, those cells straddled by the inputs of differential amplifier A function as a single combined cell 12 for the purposes of this specification, and differential amplifier A measures only the output voltage of this combined cell 12. In any event, each differential amplifier A provides an output 20 which is an output voltage indicative of the measured output voltage of its connected cell 12. Typically, each differential amplifier A provides an output 20 equal to its gain multiplied by the output voltage of its connected cell 12. For a given cell output voltage, increasing the gain of the connected differential amplifier A produces an output 20 having a proportionally greater voltage value.

In FIG. 2, all differential amplifiers A in a given group G₁, G₂ . . . Gₙ are powered by the series-connected cells 12 corresponding to that group. Referring to FIG. 2, all the differential amplifiers A in group G₁ have their positive supply terminals 24 connected in common to a point V₁ on stack 18 between the set of cells 12 corresponding to group G₁ and the set of cells 12 corresponding to group G₂, and their negative supply terminals 24 connected in common to negative stack output terminal 13. In other words, the positive supply terminals 24 of all the differential amplifiers in group G₁ are connected in common to the most positive output terminal 16 of the set of cells 12 corresponding to group G₁, and the negative supply terminals 22 of all the differential amplifiers A in group G₁ are connected in common to the most negative output terminal 14 of the set of cells 12 corresponding to group G₁, which also serves as a reference ground GND₁ for the group G₁. Each of the differential amplifiers A in group G₁ provides an output 20 proportional to the output voltage of its corresponding cell 12, with each output 20 being electrically referenced to the ground GND₁ for the group G₁.

Similarly, all the differential amplifiers A in group G₂ have their positive supply terminals 24 connected in common to a point V₂ on stack 18 between the set of cells 12 corresponding to group G₂ and the set of cells 12 corresponding to group G₃, and their negative supply terminals 24 connected in common to point V, on stack 18 between the set of cells 12 corresponding to group G₁ and the set of cells 12 corresponding to group G₂. In other words, the positive supply terminals 24 of all the differential amplifiers in group G₂ are connected in common to the most positive output terminal 16 of the set of cells 12 corresponding to group G₂, and the negative supply terminals 22 of all the differential amplifiers A in group G₂ are connected in common to the most negative output terminal 14 of the set of cells 12 corresponding to group G₂, which also serves as a reference ground GND₂ for the group G₂. Each of the differential amplifiers A in group G₂ provides an output 20 proportional to the output voltage of its corresponding cell 12, with each output 20 being electrically referenced to the ground GND₂ for the group G₂. Note that the most positive output terminal 16 of the set of cells 12 corresponding to group G₁ will also be the most negative output terminal 14 of the set of cells 12 corresponding to group G₂, and so all the positive supply terminals 24 in group G₁ will actually be connected in common to the same point V₁ to which all the negative supply terminals 22 in group G₂ are connected in common.

The same applies to each of the n groups G₁, G₂ . . . Gₙ. In the n^{th} group Gₙ, all the differential amplifiers A in group G, have their positive supply terminals 24 connected in common to positive stack output terminal 17, and their negative supply terminals 24 connected in common to a point Vₙ₋₁ on stack 18 between the set of cells 12 corresponding to group Gₙ₋₁ and the set of cells 12 corresponding to group Gₙ. In other words, the positive supply terminals 24 of all the differential amplifiers in group Gₙ are connected in common to the most positive output terminal 16 of the set of cells 12 corresponding to group Gₙ, and the negative supply terminals 22 of all the differential amplifiers A in group Gₙ are connected in common to the most negative output terminal 14 of the set of cells 12 corresponding to group Gₙ, which also serves as a reference ground GNDₙ for the group Gₙ. Each of the differential amplifiers A in group Gₙ provides an output 20 proportional to the output voltage of its corresponding cell 12, with each output 20 being electrically referenced to the ground GNDₙ for the group Gₙ. The specific number of differential amplifiers A, and corresponding cells 12, shown in each group G₁, G₂ . . . Gₙ in FIG. 2 is for illustration purposes only; each group G₁, G₂ . . . Gₙ can have any number of differential amplifiers A and corresponding cells 12 depending on operational requirements.

Given the power supply connections described above, it will be clear to one skilled in the art that the magnitude of the supply voltages to differential amplifiers A belonging to the same group G₁, G₂ . . . Gₙ will be equal. In particular, the value of the supply voltage to the differential amplifiers A belonging to each group G₁, G₂ . . . Gₙ will be equal to the sum of the output voltages of the series-connected cells 12 corresponding to that group G₁, G₂ . . . Gₙ.

Typically, stack 18 supplies DC electrical energy to a load 30 (not shown) connected between the negative stack output terminal 13 and the positive stack output terminal 17. As the magnitude of the load applied to stack 18 changes, the stack current will change correspondingly. Changes in the stack current typically causes the stack voltage to change correspondingly. For a typical battery or fuel cell stack, as is well known in the art, the stack voltage decreases slightly as the stack current increases and the stack voltage increases slightly as the stack current decreases. Such changes or fluctuations in the stack voltage cause corresponding fluctuations in the supply voltages to the differential amplifiers A. Fluctuations in the supply voltages to the differential amplifiers A are acceptable provided that the supply voltage to each differential amplifier A continues to be greater than the minimum required supply voltage for that differential amplifier A and provided that the output 20 of each differential amplifier A continues to be less than the maximum output voltage capability of that differential amplifier A.

Several additional features of the present invention make the cell voltage monitoring device 10B and corresponding method more effective by increasing its immunity to fluctuations in the supply voltages to differential amplifiers A. These additional features include:
(i) appropriately selecting the number of differential amplifiers A in each group G₁, G₂ . . . Gₙ; (ii) appropriately selecting the gain of the circuit of each differential amplifier A; and (iii) determining circumstances in which an output 20 should be rejected as unreliable, and having means for disregarding unreliable outputs. These additional features of the present invention are described below.

The number of differential amplifiers A belonging to each group G₁, G₂ . . . Gₙ is preferably selected so that the minimum expected supply voltage to the differential amplifiers A belonging to that group is greater than the minimum required supply voltage for each differential amplifier A in that group. As is well known in the art, the minimum required supply voltage of a differential amplifier A is a characteristic design feature of that differential amplifier A. For specific differential amplifiers purchased from a manufacturer of differential amplifiers, the minimum required supply voltage for the specific differential amplifier is typically obtainable from the manufacturer. In cell voltage monitoring device 10B, as explained above, the value of the supply voltage to the differential amplifiers A belonging to a given group G₁, G₂ . . . Gₙ is equal to the sum of the output terminal voltages of the series-connected cells 12 corresponding to that group. Accordingly, the expected value of the supply voltage to the differential amplifiers A belonging to one group G₁, G₂ . . . Gₙ is equal to the sum of the expected output terminal voltages of the series-connected cells 12 corresponding to that group, and the minimum expected value of the supply voltage to the differential amplifiers A belonging to one group G₁, G₂ . . . Gₙ is equal to the sum of the expected minimum output terminal voltages of the series-connected cells 12 corresponding to that group. The expected supply voltage and minimum expected supply voltage corresponding to each group G₁, G₂ . . . Gₙ are variable within ranges determined by characteristic design features of the cells 12 corresponding to that group and by the number of differential amplifiers A and corresponding cells 12 belonging to that group. As the number of differential amplifiers A in each group G₁, G₂ . . . Gₙ increases, and therefore also the number of corresponding cells 12 in that group, the value of the minimum expected supply voltage to those differential amplifiers A in the group increases. Each additional cell 12 measured by a corresponding additional differential amplifier A in a group G₁, G₂ . . . Gₙ increases the supply voltage of the differential amplifiers A belonging to that group by the value of the output voltage of that additional cell 12. However, having too many differential amplifiers A in a group G₁, G₂ . . . Gₙ may cause the supply voltages of the differential amplifiers A in that group to exceed certain design parameters of those differential amplifiers A, since the maximum expected supply voltage provided by the corresponding set of cells 12 to the differential amplifiers A must, of course, be kept below the maximum allowable supply voltage for the differential amplifiers A. Further, having too many differential amplifiers A and corresponding cells 12 in a group G₁, G₂ . . . Gₙ may give rise to the problem identified by Torii et al. with respect to background currents. At the same time, having too many groups G₁, G₂ . . . Gₙ may result in a corresponding need for a correspondingly large number of isolation circuits for converting differential amplifier outputs 20 from each of those groups G₁, G₂ . . . Gₙ to a common reference ground for processing by a common CPU (as explained below). By appropriately selecting the number of differential amplifiers A that belong to each group G₁, G₂ . . . Gₙ, the minimum expected supply voltage to the differential amplifiers A belonging to that group can be maintained greater than the minimum required supply voltage of each differential amplifier A in that group, all without exceeding design parameters for those differential amplifiers A or needlessly causing background current problems. By such a selection, the supply voltage to the differential amplifiers A belonging to each group G₁, G₂ . . . Gₙ will only become less than the minimum required supply voltage of each differential amplifier A in that group or more than the maximum in exceptional circumstances. Preferably, the number of differential amplifiers A in each group G₁, G₂ . . . Gₙ is selected such that the minimum expected supply voltage to the differential amplifiers A is significantly above the minimum required supply voltage for the differential amplifiers A in the group for all expected operating conditions; by doing so, even in the exceptional case where several cells 12 within the group G₁, G₂ . . . Gₙ fail completely, the expected supply voltage to the differential amplifiers A will still remain above the minimum required supply voltage for those differential amplifiers A.

Another way of making cell voltage monitoring device 10B more immune to fluctuations in supply voltages to the differential amplifiers A involves selecting the gain of the circuit of each differential amplifier A so that the maximum expected value of each output 20 is less than the maximum output capability of that differential amplifier A. The maximum output capability of a differential amplifier A is the maximum output voltage that the differential amplifier A can provide. As is well known in the art, the maximum output capability of a differential amplifier A is dependent upon the supply voltage of that differential amplifier A and is typically a voltage which is equal to or slightly less than the supply voltage for that differential amplifier A. The relationship of dependency between the maximum output capability of a differential amplifier A and its supply voltage is a characteristic design feature of that differential amplifier A. The maximum output capability of a specific differential amplifier, as a function of the supply voltage applied to it, is typically obtainable from the manufacturer. As described above, selecting a higher gain for the circuit of a differential amplifier A produces an output having a greater voltage value for a given output voltage across the corresponding cell 12. The greater the value of an output 20, the greater the likelihood that the output 20 will exceed the maximum output capability of the corresponding differential amplifier A. If the gain of the circuit of a differential amplifier A is too low, however, effective cell voltage monitoring will be compromised. By appropriately selecting the gain of the circuit of each differential amplifier A, the output 20 provided by each differential amplifier A can be maintained at a value less than the maximum output capability of that differential amplifier A.

The design of cell voltage monitoring device 10B as shown in FIG. 2 reduces the number of components in a cell voltage monitoring system. However, the design of both cell voltage monitoring device 10B and the prior art cell voltage monitoring device 10A in FIG. 1 produce outputs 20 proportional to the output voltages of the cells 12 where the outputs 20 are referenced to different potentials along the stack 18. It is known in the art for such outputs 20 to be input into a controller that implements the cell voltage monitoring method, but having each group G₁, G₂ . . . Gₙ referenced to a different ground makes it difficult to process the outputs 20 using a common controller.

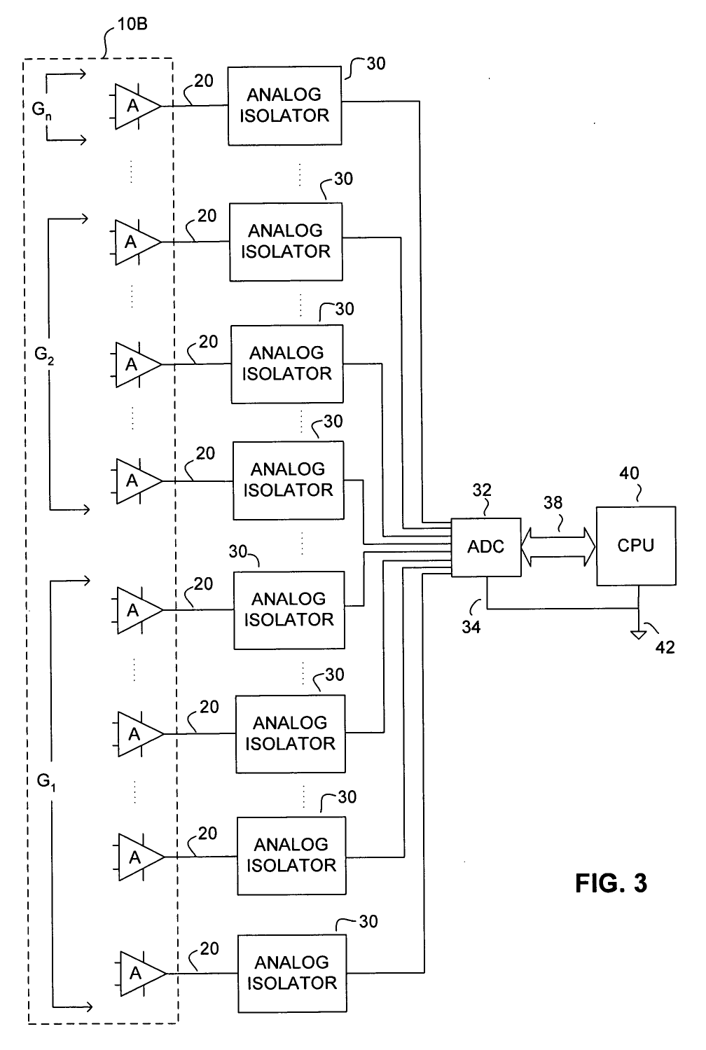

Preferably, the cell voltage monitoring device 10B converts the outputs 20 from different groups G₁, G₂ . . . Gₙ to a common reference ground for processing by a common controller. FIG. 3 is a circuit diagram implementing one possible method of converting outputs 20 to a common reference ground for processing by a controller in the form of a CPU 40. As shown in FIG. 3, the conversion may be done by providing an analog isolator 30, such as an analog isolation amplifier, for each differential amplifier A and, in particular, by passing each output 20 through an analog isolator 30 to amplify and DC shift the analog voltage values of outputs 20 so that all the outputs 20 become referenced to a common analog ground reference. Each analog isolator 30 amplifies its input in a manner that isolates the circuitry connected to its output from the circuitry connected to its input. The gain of each analog isolator 30 may be of any suitable value, including greater than one, unity, or less than one. Once amplified and DC shifted to a common analog ground reference, the commonly referenced analog outputs of the analog isolators 30 are preferably digitized before they are processed by CPU 40. FIG. 3 shows a single analog-to-digital converter (ADC) 32 which digitizes the outputs of the analog isolators 30. The sampled digital outputs of ADC 32 are then communicated to CPU 40, which may be any central processing unit, microprocessor or computer capable of performing the digital processing of the present invention. The digitization performed by ADC 32 is voltage referenced to a voltage selected to ensure that the range of analog input voltages capable of being accurately digitized by ADC 32 encompasses the range of analog input voltages applied to the input of ADC 32. Voltage referencing ADC 32 is accomplished by connecting the voltage reference terminal 34 of ADC 32 to a suitable voltage source. In the embodiment illustrated in FIG. 3, the voltage source is the digital ground terminal 42 of CPU 40. It is not necessary that there be only one ADC 32 or only one CPU 40. As will be apparent to those skilled in the art, there are many possible schemes to communicate and process the outputs 20.

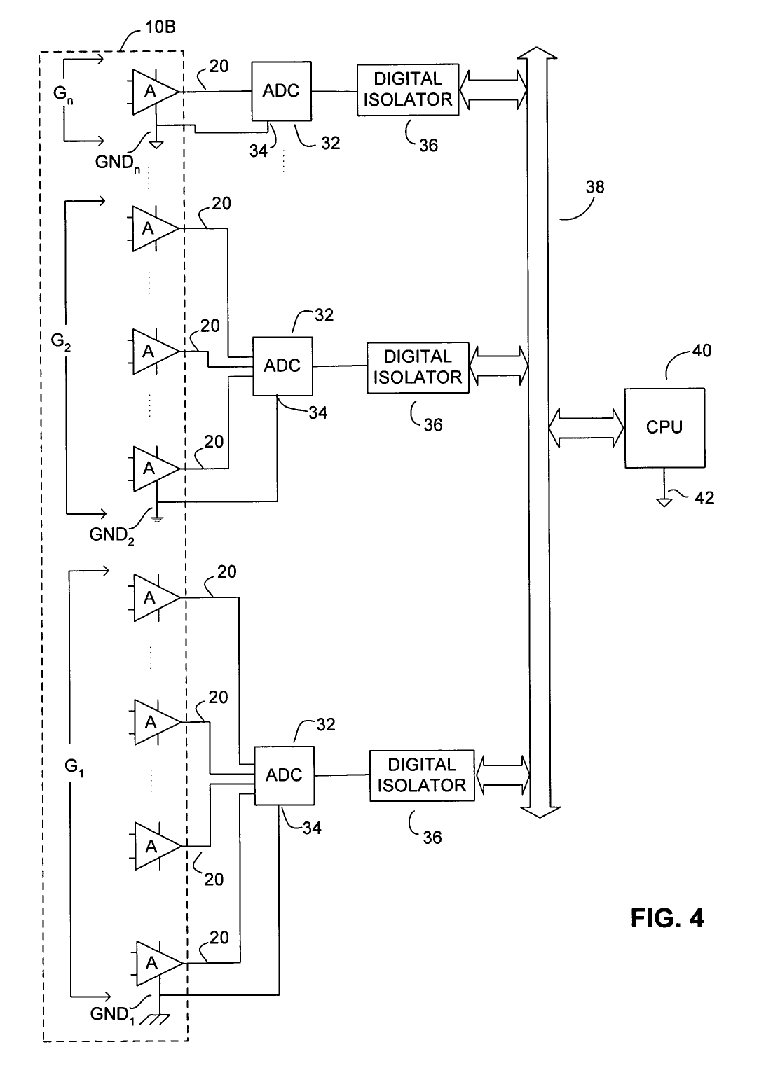

The method of converting outputs 20 to a common reference ground illustrated in FIG. 3 requires one analog isolator 30 for each cell 12, which greatly increases the cost of the system given the expense of analog isolators. For this reason, one preferred approach would be to first digitize the analog outputs 20 and then convert the digital outputs to a common reference ground using much cheaper digital conversion means. FIG. 4 is a circuit diagram of a preferred digital implementation of converting outputs 20 to a common reference ground, wherein analog outputs 20 are sampled by a plurality of ADC 32 (alternatively, a single with MUX), each implemented on an integrated circuit, without isolating those outputs 20 first. Preferably, there is at least one ADC 32 per group G₁, G₂ . . . Gₙ which digitizes all outputs 20 corresponding to that group. The digitization performed by each ADC 32 is voltage referenced to a voltage selected to ensure that the range of analog input voltages capable of being accurately digitized by each ADC 32 typically encompasses the range of analog input voltages applied to the input of that ADC 32. Voltage referencing each ADC 32 is accomplished by connecting the voltage reference terminal 34 of each ADC 32 to a suitable voltage source. The suitable voltage source for each ADC 32 corresponding to a given group G₁, G₂ . . . Gₙ may be an output terminal potential of one of the series-connected cells 12 corresponding to that same group. The output terminal potential of a cell 12 is the electrical potential at an output terminal 14, 16 of that cell 12. In the embodiment illustrated in FIG. 4, the reference voltage source for each ADC 32 is the electrical potential of the most negative output terminal 14 of the set of series-connected cells 12 corresponding to the group G₁, G₂ . . . Gₙ served by that ADC 32, which also corresponds to the respective reference ground GND₁, GND₂ . . . GNDₙ for that group. However, other voltage referencing schemes determined by characteristic features of a particular ADC 32 may be used.

Referring to FIG. 4, the digital outputs of the plurality of ADC 32 are passed through digital isolators 36 which convert the digitized values to a common digital reference that is shared with the CPU 40. Each digital isolator 36 reproduces its input at its output in a manner which isolates the digital circuitry connected to its output from the digital circuitry connected to its input. The digitally isolated outputs of the digital isolators 36 are communicated via serial bus 38 to CPU 40. The serial communication between each ADC 30 and CPU 40 can be any conceivable protocol—for example, SPI, RS-232, RS-485, or CAN Bus. Using ADC 32 with serial communication interfaces allows the sampled voltages to be sent to CPU 40 through digital isolators 36 in the form of inexpensive digital opto-couplers or similar devices. From at least a cost perspective, the system shown in FIG. 4 using inexpensive digital isolators 36 is preferred over the system shown in FIG. 3 using expensive analog isolators. In the system illustrated in FIG. 4, only one digital isolator 36 is required for each group G₁, G₂ . . . Gₙ, compared with one analog isolator 30 for each output 20 in the system in FIG. 3. The plurality of integrated circuit ADC 32 can also be replaced by inexpensive CPUs with their own onboard ADCs. Lastly, it is not necessary that there be only one ADC 32 per group G₁, G₂ . . . Gₙ, only one serial bus 38 or only one CPU 40. As will be apparent to those skilled in the art, there are many possible schemes to communicate and process the outputs 20.

Reducing the number of groups G₁, G₂ . . . Gₙ in cell voltage monitoring device 10B is desired to reduce the overall cost of cell voltage monitoring device 10B, since the ability to compare outputs from different groups G₁, G₂ . . . Gₙ or to collect outputs 20 into a common CPU 40 requires the use of isolation circuits such as analog isolators 30 or digital isolators 36. As mentioned, such isolation circuits, especially analog isolators 30, are expensive, and it is therefore desirable to keep the number of isolation circuits as small as possible. However, this does not necessarily mean that analog outputs 20 must be digitized, digitally isolated, and processed by a digital controller. It is possible to use process outputs 20 using entirely analog circuitry, but, to reduce costs, it is important to reduce the number of outputs 20 that need to be isolated.

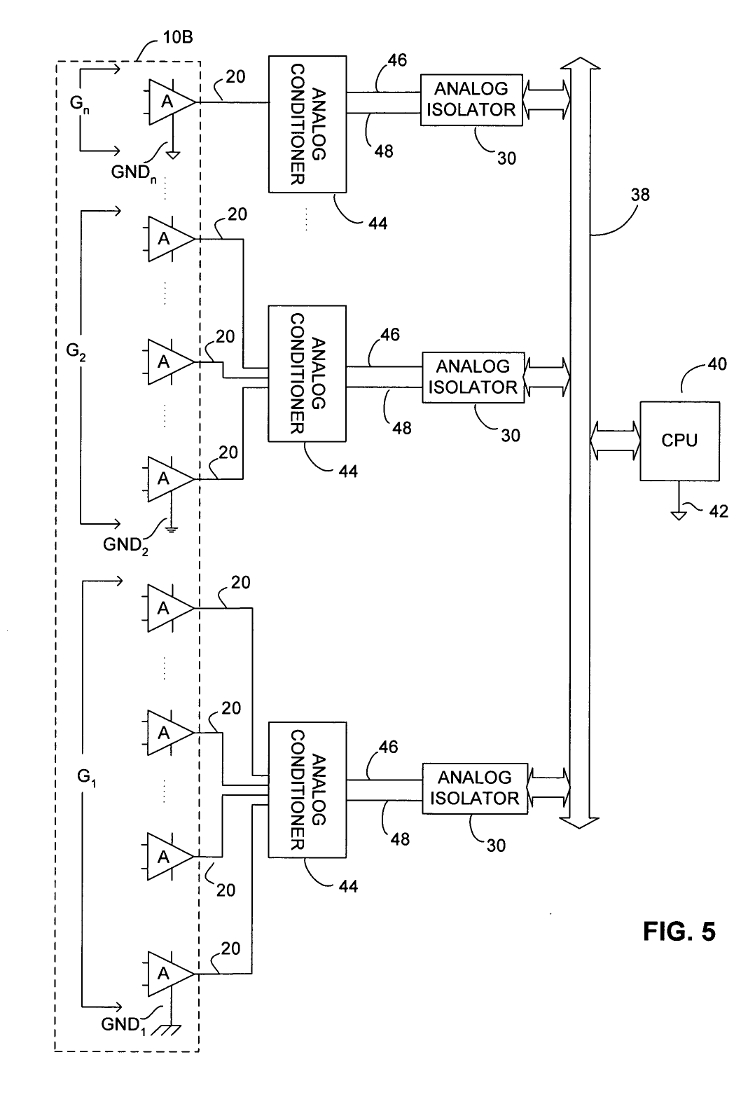

FIG. 5 is a preferred analog method of converting outputs 20 to a common reference ground, whereby outputs 20 undergo some form of analog conditioning or filtering to reduce the number of signals before analog isolation to a common ground. Referring to FIG. 5, all outputs 20 in a given group G₁, G₂ . . . Gₙ are processed by an analog conditioner 44 to reduce the number of signals prior to processing by an analog isolator 30 for that group G₁, G₂ . . . Gₙ. In FIG. 5, each analog conditioner 44 receives all the outputs 20 of a corresponding group G₁, G₂ . . . Gₙ and outputs to the analog isolator 30 only the maximum voltage 46 and minimum voltage 48 among those outputs 20. In an alternative embodiment (not shown), analog conditioner 44 outputs the maximum voltage 46 and minimum voltage 48 as well as the average voltage among those outputs 20, in which case more than one analog isolator 30 may be needed per group G₁, G₂ . . . Gₙ. In either of these implementations, each analog conditioner 44 can be an analog conditioning circuit such as that described in U.S. Pat. No. 5,652,501 or any other conceivable analog circuit for reducing the number of voltage signals. By using analog conditioners 44 to reduce the number of signals, a reduced number of analog isolators 30 is required, thereby greatly reducing the cost of the circuit by reducing the number of isolators.

Regardless of what approach is used to convert outputs 20 to a common reference ground for processing by CPU 40, the CPU 40 has a role to play in analyzing and disregarding unreliable outputs 20. Under exceptional circumstances, even appropriately selecting the number of cells 12 and differential amplifiers A in any given group G₁, G₂ . . . Gₙ, and appropriately selecting the gains of the differential amplifiers A, will not be enough to prevent all erroneous outputs 20. For example, a problem can occur when the stack voltage of the stack 18 is very low during stack start-up or if a very large number of cells 12 corresponding to the same group G₁, G₂ . . . Gₙ fail at the same time. This could potentially result in the supply voltage to the differential amplifiers in a group G₁, G₂ . . . Gₙ falling below the minimum required supply voltage for those differential amplifiers A, or result in the outputs 20 being clipped below the proper value. The outputs 20 of those differential amplifiers A would be indeterminate in this condition, and could potentially, erroneously indicate a voltage corresponding to a “good” cell voltage, resulting in a dangerous misinterpretation of the operating health of the stack 18. Another corrective approach therefore relates to determining circumstances in which a measurement must be disregarded as unreliable, and having means for rejecting unreliable outputs and taking corrective action. A cell output voltage measurement can be determined to be unreliable by comparing the stack or group voltages and stack current measurements with a known stack polarization, and a CPU for processing such measurements can reject such unreliable measurements and take corrective action.

In a preferred embodiment of the invention, CPU 40 processes, including possibly rejecting, stored values corresponding to the outputs 20. Rejecting a stored value includes flagging the stored value as unreliable, discarding the stored value, or taking other action in response to a determination of unreliability. CPU 40 determines whether a given stored value should be rejected by considering measurements of the overall stack voltage and considering whether or not they fall within expected parameters, or by hardware circuitry that signals CPU 40 if the bank voltages of cells 12 within a group G₁, G₂ . . . Gₙ are not sufficient. This hardware circuitry can be as simple as a voltage comparator circuit.

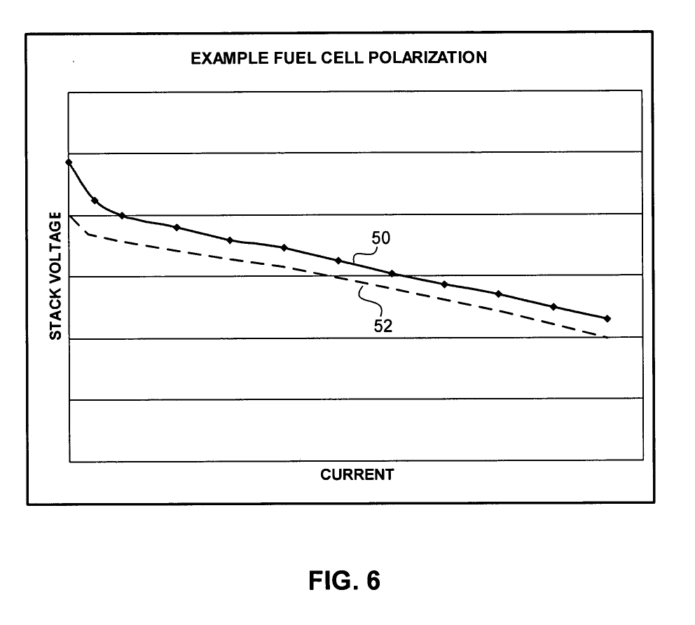

FIG. 6 is a graph with two curves 50, 52 showing respectively the expected and minimum allowable stack voltage for a given stack current. Referring to FIG. 6, a stack polarization curve 50 represents the expected stack voltage for a given stack current, and a threshold level curve 52 represents the minimum acceptable stack voltage for a given stack current. Values of the stack voltage which are below the threshold level shown by the threshold level curve 52 in FIG. 6 are not within an acceptable range of stack voltages, and may be disregarded by CPU 40 as an overriding condition has been achieved. In the preferred embodiment, CPU 40 will have stored in its memory data corresponding to the threshold level curve 52 shown in FIG. 6, and include software for comparing the measured stack voltage against the threshold level curve 52 for a given measured stack current. The overall stack voltage and the stack current are measured as part of the cell voltage monitoring system of the invention, and are measured by circuitry and devices and methods which are well known in the art. For example, the stack current can be measured by a current sensor and be sampled by the CPU 40; the stack voltage can similarly be monitored with appropriate hardware so that it can be reliably measured at all times regardless of the voltages corresponding to particular groups G₁, G₂ . . . Gₙ. If the stack voltage is less than the threshold level for a given stack current, CPU 40 may reject all stored values corresponding to the rejected outputs 20 and may likely take corrective or fault action, such as shutting down the stack 18.

As an alternative to continuously comparing the measured stack voltage against a known stack polarization curve, the cell voltage monitoring system of the invention may simply include circuitry for monitoring the stack or group voltages and signaling CPU 40 when the measured stack or group voltage falls below a predetermined threshold. Also, the system may include software that compares measured stack voltage against expected levels periodically or at specific times.

As will be apparent to those skilled in the art in the light of the foregoing disclosure, many alterations and modifications are possible in the practice of this invention without departing from the spirit or scope thereof. For example, the digital communications between ADC 32 and CPU 40 in FIG. 3 may be serial or parallel or any other suitable method of digital communications. Accordingly, the scope of the invention is to be construed in accordance with the substance defined by the following claims.

1. A cell voltage monitoring device for monitoring respective cell output voltages of a stack of series-connected cells, each cell having a positive output terminal and a negative output terminal, said cell voltage monitoring device comprising a plurality of differential amplifiers wherein:
(a) each differential amplifier corresponds to a cell within the stack and has a first input connected to the positive output terminal of the corresponding cell and a second input connected to the negative output terminal of the corresponding cell;
(b) each differential amplifier has a negative supply terminal and a positive supply terminal;
(c) the plurality of differential amplifiers is divided into groups, each group corresponding to a set of series-connected cells within the stack;
(d) within each group of differential amplifiers, the positive supply terminal of each differential amplifier is connected to the most positive output terminal of the set of series-connected cells corresponding to that group; and
(e) within each group of differential amplifiers, the negative supply terminal of each differential amplifier is connected to the most negative output terminal of the set of series-connected cells corresponding to that group.

2. The cell voltage monitoring device of claim 1 wherein, within each group of differential amplifiers, the sum of the minimum expected output voltages of the corresponding set of series-connected cells is greater than the minimum required supply voltage of each differential amplifier.

3. The cell voltage monitoring device of claim 1 wherein, within each group of differential amplifiers, the sum of the maximum expected output voltages of the corresponding set of series-connected cells is less than the maximum allowable supply voltage of each differential amplifier.

4. The cell voltage monitoring device of claim 1 wherein each differential amplifier has a gain such that the maximum expected voltage output of the differential amplifier is less than its maximum voltage output capability.

5. The cell voltage monitoring device of claim 1, wherein outputs from the differential amplifiers are connected through isolator input circuitry to the inputs of corresponding isolators for converting the outputs to a common reference ground.

6. The cell voltage monitoring device of claim 5, wherein the isolators are analog isolators.

7. The cell voltage monitoring device of claim 6, wherein each of the isolators corresponds to one of the groups of differential amplifiers, and wherein the isolator input circuitry comprises an analog conditioner connected between the input of each isolator and the outputs of all differential amplifiers within the corresponding group, for reducing the number of differential amplifier outputs in each group that require isolation.

8. The cell voltage monitoring device of claim 7, wherein each analog conditioner passes to its corresponding isolator the maximum and minimum outputs of the outputs of its corresponding group of differential amplifiers.

9. The cell voltage monitoring device of claim 6, wherein the isolator input circuitry comprises direct connections between the output of each differential amplifier and the input of the corresponding isolator.

10. The cell voltage monitoring device of claim 6, further comprising an analog-to-digital converter connected to the outputs of the isolators for digitizing the outputs of the isolators.

11. The cell voltage monitoring device of claim 5, wherein the isolators are digital isolators.

12. The cell voltage monitoring device of claim 11, wherein each of the isolators corresponds to one of the groups of differential amplifiers, and wherein the isolator input circuitry comprises an analog-to-digital converter connected between the input of each isolator and the outputs of all differential amplifiers within the corresponding group, for digitizing the outputs of the differential amplifiers of the group and passing a digitized output to the isolator.

13. The cell voltage monitoring device of claim 12, wherein the analog-to-digital converter for each group of differential amplifiers is voltage referenced to the potential of the most-negative output terminal of the corresponding set of series-connected cells.

14. The cell voltage monitoring device of claim 5, wherein the output of each isolator is connected via CPU input circuitry to a CPU for determining the overall cell output voltages.

15. The cell voltage monitoring device of claim 14, further comprising circuitry for signaling the CPU when the corresponding stack or group voltage falls below a predetermined threshold.

16. The cell voltage monitoring device of claim 14, further comprising software for comparing the corresponding stack or group voltage against expected values.

17. The cell voltage monitoring device of claim 14, wherein the CPU rejects overall cell output voltages when a corresponding stack or group voltage is not within an acceptable range in relation to a corresponding stack current.

18. A method of monitoring respective cell voltages of a stack of series-connected cells, each cell having a positive output terminal and a negative output terminal, comprising the steps of:
(a) measuring the respective cell voltages using a plurality of differential amplifiers, each differential amplifier corresponding to a cell within the stack; and
(b) powering the differential amplifiers using only cells within the stack.

19. The method of claim 18, further comprising the step of dividing the plurality of differential amplifiers into groups, each group corresponding to a set of series-connected cells within the stack, and wherein each group of differential amplifiers is powered using only the set of series-connected cells corresponding to that group.

20. The method of claim 19, further comprising, with respect to the dividing of the plurality of differential amplifiers into groups, the step of selecting a number of differential amplifiers for each group such that the sum of the minimum expected output voltages of the set of series-connected cells corresponding to that group is greater than the minimum required supply voltage of each differential amplifier within the group.

21. The method of claim 19, further comprising, with respect to the dividing of the plurality of differential amplifiers into groups, the step of selecting a number of differential amplifiers for each group such that the sum of the maximum expected output voltages of the set of series-connected cells corresponding to that group is less than the maximum allowed supply voltage of each differential amplifier within the group.

22. The method of claim 19, further comprising, with respect to the differential amplifiers, the step of selecting only differential amplifier circuits having a sufficiently low gain such that the maximum expected output of each differential amplifier is less than its maximum output capability.

23. The method of claim 19, further comprising the step of converting the outputs of the differential amplifiers to a common reference ground.

24. The method of claim 23, wherein the conversion is achieved by passing the outputs of the differential amplifiers through analog isolators.

25. The method of claim 24, further comprising, prior to the conversion step, analog conditioning of the outputs of the differential amplifiers to reduce the number of outputs to convert to the common reference ground.

26. The method of claim 25, wherein:
(a) each of the analog isolators corresponds to one of the groups of differential amplifiers; and
(b) the analog conditioning step comprises passing only the maximum and minimum outputs of the differential amplifiers within that group to the analog isolator corresponding to that group.

27. The method of claim 24, further comprising the step of digitizing the output of the analog isolators.

28. The method of claim 23, further comprising, prior to the conversion step, digitizing the outputs of the differential amplifiers to provide a digital output for each group of differential amplifiers, and wherein the conversion is achieved by passing the digitized outputs through digital isolators.

29. The method of claim 23, further comprising, with respect to the dividing of the plurality of differential amplifiers into groups, the step of minimizing the number of groups, in order to reduce the number of isolators required to convert the outputs of the differential amplifiers to a common reference ground.

30. The method of claim 23 further comprising the step of processing the converted outputs through a CPU to determine the cell voltages.

31. The method of claim 30, further comprising the steps of:
(a) measuring a corresponding stack or group voltage; and
(b) rejecting a converted output when the corresponding stack or group voltage is not within acceptable parameters.

32. The method of claim 31, further comprising signaling the CPU when the corresponding stack or group voltage falls below a predetermined threshold.

33. The method of claim 31, further comprising measuring a corresponding stack current, and wherein the rejection step involves rejecting a converted output when the corresponding stack voltage in relation to the corresponding stack current is not within an acceptable range.
